(19) United States
(12) Patent Application Publication
(10) Pub. No.: US 2006/0103260 A1
(43) Pub. Date: May 18, 2006

(54) Motor for an electrically-operated latch

(76) Inventors: Philippe Ottolini, La Voivre (FR); Jean-Marc Belmond, St. Jean Le Blance (FR); Jean-Pierre Noel, Raon L'Etape (FR)

Correspondence Address: CARLSON, GASKEY & OLDS, P.C., 400 WEST MAPLE ROAD, SUITE 350, BIRMINGHAM, MI, 48009, US

(21) Appl. No.: 11/272,020

(22) Filed: Nov. 10, 2005

(30) Foreign Application Priority Data
Nov. 12, 2004 (FR) 04 12 023

(51) Int. Cl. H02K 11/00; H02K 5/00; H01R 39/38

(52) U.S. Cl. 310/239; 310/71; 310/89

(57) ABSTRACT

An electric motor includes a rotor and a commutator housing having at least two flexible conductors connected to brush holders. The flexible conductors provide a connection to electrical supply posts which extend parallel to an axis of the rotor. The motor can thus be assembled into a housing, such as a vehicle door latch housing, with the axis of the rotor parallel to the electrical supply posts without needing a supplementary assembly component.

### REFERENCE TO RELATED APPLICATION

This application claims priority to French Patent Application FR 04 12 023 filed on Nov. 12, 2004.

### BACKGROUND OF THE INVENTION

The present invention relates generally to an electric motor and a latch housing including the electric motor.

A latch is designed to keep an openable member (such as a door) of an automobile vehicle in a closed position. It also allows the openable member to be opened by operating an inside or external control connected to the latch that is operable by a user. The latch is typically mounted on the openable member of the vehicle.

Numerous designs of electrically-operated latches exist in which a release/locking mechanism is driven by a gear mechanism operated by an electric motor. Electrically-operated latches are able to partially or fully provide various functions such as locking (preventing the latch being released by an outside handle), unlocking, security locking (preventing the latch being released by an inside handle), release of the security locking, activation/deactivation of a child safety feature or override.

European patent application EP-A-1 335 087 describes various designs of prior art latches along with an electrically-operated latch which allows the above functions to be provided under degraded electrical conditions.

Herein, we use the term “latch housing” to signify a housing incorporating at least part of the electric components of the latch, such as the motor or motors, lever position sensors, memories, printed electrical track, processors or the like. The housing can at least partially be made of molded plastic.

An electric motor generally includes a stator frame and a rotor rotatively mounted inside the stator. The motor also includes windings integral with the rotor shaft, and each winding is electrically connected to two diametrically opposed segments of a commutator mounted on the rotor shaft. The commutator is generally fitted inside a commutator end plate or housing integral with the stator.

The commutator end plate or housing includes a support in insulating material, such as plastic material, with an opening adapted to receive the commutator and to allow the rotor shaft to pass through. The commutator housing also includes at least one pair of diametrically opposed brushes adapted to wipe against the commutator segments during their rotation integral with the rotor shaft. The brushes are electrically connected to an electrical power supply. When the motor is running, as is known, the brushes are pressed against the commutator segments and successively power the various windings corresponding to the various pairs of diametrically opposed segments when the commutator rotates with the rotor.

With reference now to FIG. 1, it is known to mount a latch motor 60 in a latch housing 100 by positioning it with an axis of a rotor 10 parallel to the base plane of the latch housing 100. Such an assembly can, for example, be seen in Assignee's XI-N3 type latches designed for the Peugeot 406 vehicle model. The latch motor 60 is connected to electrical supply posts 110 via connection holes 45 provided in a motor commutator housing 50. The electrical supply posts 110 thereby supply the brushes mounted in the commutator housing 50 to operate the latch motor 60. The electrical supply posts 110 of the latch motor 60 project perpendicularly from the base of the latch housing 100 from electrical supply tracks provided in the bottom of the latch housing 100, for example overmolded in the plastic of the latch housing 100. The electrical supply posts 110 consequently plug into the commutator housing 50 perpendicular to the axis of the rotor 10 of the latch motor 60.

When it becomes necessary to install the latch motor 60 in the latch housing 100 with the axis of the rotor 10 perpendicular to the general plane of the latch housing 100, for example because such a positioning is made necessary by the arrangement of the gears to be driven, it is necessary to employ a supplementary assembly component to be able to connect the electrical supply posts 110 to the latch housing connection holes 45 of the commutator housing 50. Providing a supplementary assembly component is expensive and complicates manufacture of the latch.

There is consequently a need for an electric motor that allows for assembly with electrical supply posts parallel to the axis of the rotor of the latch motor.

### SUMMARY OF THE INVENTION

The present invention provides an electric motor including a rotor and a commutator housing. The commutator housing includes at least two connection members connected to brush holders, and the connection members are adapted to connect electrical supply posts. The electrical supply posts extend parallel to an axis of the rotor.

Depending on the embodiment, the electric motor may include one or more of the following features. The connection members can extend in a plane substantially perpendicular to the axis of the rotor. The connection members can be flexible tongue members, and the flexible tongue members can each have a first bossed region adapted to establish contact with the electrical supply posts and a second bossed region adapted to establish contact with the brush holders. The connection members can be of unit construction with the brush holders. The commutator housing can include at least two slots adapted to receive the electrical supply posts. The commutator housing can include a groove adapted to receive an angular positioning stud for the electric motor.

An electrically-operated latch is also provided. The latch includes a latch housing having a base and side walls, a motor as disclosed herein mounted in the latch housing with the axis of the rotor perpendicular to the base of the housing, and at least two electrical supply posts extending parallel to the axis of the rotor and electrically connected to the connection members of the motor.

Depending on the embodiment, the electrically-operated latch may include one or more of the following features. The electrical supply posts can be overmolded inside a connection conduit extending in elevation parallel to a side wall of the latch housing. The connection conduit of the latch housing can include a stud adapted to cooperate with a groove of the commutator housing for angular positioning of the motor. The connection conduit of the latch housing can have at least one abutment for axial positioning of the motor.

The invention applies to any openable member of a vehicle that includes an electrically-operated latch according to the invention.

Further characteristics and advantages of the invention will become more clear from the description which follows of some embodiments, provided solely by way of example and with reference to the attached drawings.

### BRIEF DESCRIPTION OF THE DRAWINGS

FIG. 1, already described, is a diagrammatic view of an electric motor according to the prior art mounted perpendicular to electrical supply posts of a housing;

FIG. 2 shows, diagrammatically, an electric motor mounted in a latch housing according to the invention;

FIG. 3 is a detailed view of the assembly of the supporting member for supporting the commutator end cap or the latch housing of the electric motor according to the invention;

FIG. 4 is a detailed view of the commutator housing of the electric motor according to the invention; and

FIG. 5 shows the wiring and connections in the latch housing of FIG. 2.

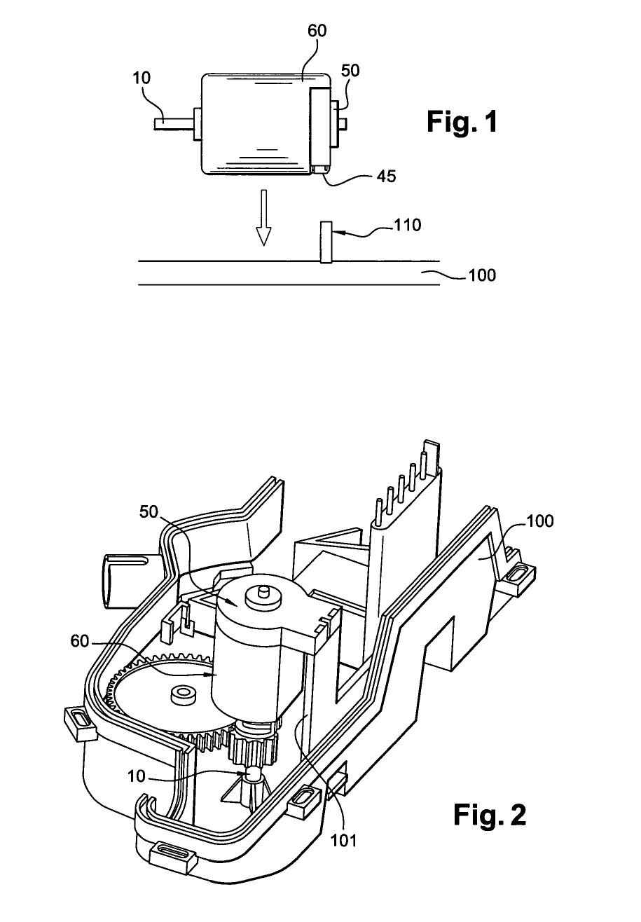

### DETAILED DESCRIPTION OF PREFERRED EMBODIMENTS

The electric motor of the present invention includes a rotor and a commutator end plate or housing. The commutator housing includes at least two connection members connected to brush holders. The connection members are adapted to connect electrical supply posts that extend parallel to an axis of a rotor.

Thus, the electric motor can be assembled in a housing, such as a latch housing, with the axis of the rotor substantially parallel to the electrical supply posts without the need for a supplementary component in the assembly. In effect, the connection members are integrated into the commutator housing and extend to electrically connect the brush holders to the electrical supply posts.

FIG. 2 shows such an assembly of a motor with an axis of a rotor parallel to electrical supply posts. The description below makes reference to an electrically operated latch which constitutes an application in which a motor can be mounted in a housing with the axis of the rotor parallel to the electrical supply posts. It should nevertheless be understood that other applications can be envisioned, and the illustrated housing can be designed for functions other than a latch or a lock.

FIG. 2 shows a latch housing 100 including a base and side walls. A latch motor 60 is mounted in the latch housing 100, an axis of a rotor 10 is substantially perpendicular to a bottom of the latch housing 100. This arrangement of the latch motor 60 in the latch housing 100 is rendered essential by the arrangement of the gears to be driven by the latch motor 60.

FIG. 2 also shows electrical supply posts 110 which project from a top of a connection conduit 101 extending parallel along a side wall of the latch housing 100. The electrical supply posts 110 extend substantially parallel to the axis of the rotor 10. This arrangement of the electrical supply posts 110 results from housing manufacturing constraints. In effect, the latch housing 100 it generally produced by injection molding. It is difficult, or even impossible, to overmold electrical connections, in order to insulate them, in the connection conduits 101 that extend substantially perpendicularly from the side walls of the latch housing 100.

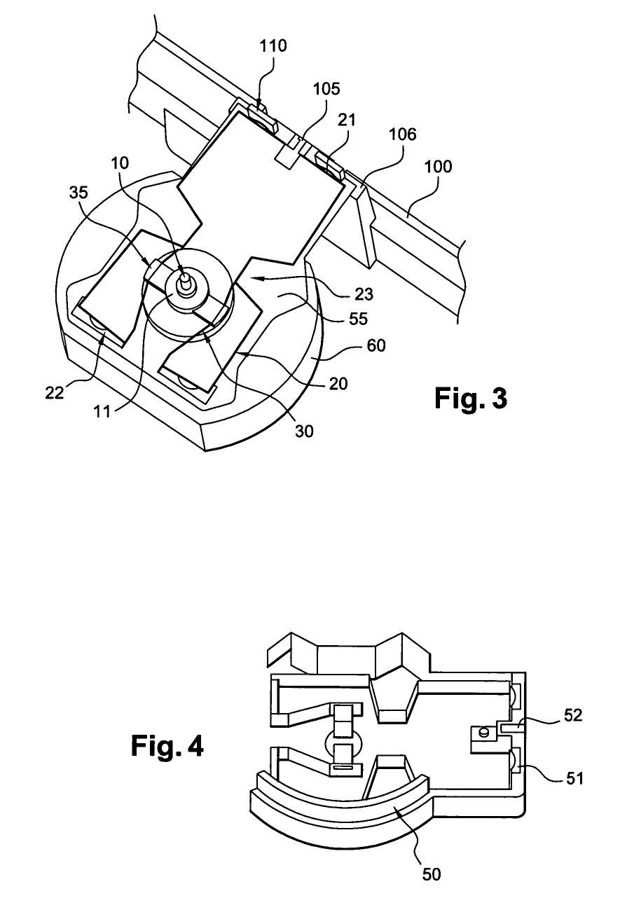

FIG. 2 shows that the electrical supply posts 110 are electrically connected to the latch motor 60 by inserting them into a commutator housing 50 which has an appropriate shape. In particular, a first part of the commutator housing 50 is substantially circular and adapted to the shape of the motor stator periphery, while a second substantially rectangular part extends from the circular part to meet the end of the connection conduit 101 from which the electrical supply posts 110 extend. The commutator housing 50 cooperates with the end portion of the connection conduit 101, in particular with mating mechanical members 105, 106, 51, 52, as will be described in more detail with reference to FIGS. 3 and 4.

FIG. 3 shows a supporting member 55 for supporting the commutator housing 50 in a top view, in other words from a rear of the stator in the example illustrated. FIG. 4 shows the commutator housing 50 open.

FIG. 3 shows that the supporting member 55, generally a plastics material plate, has a shape corresponding to the shape previously described for the commutator housing 50. FIG. 3 shows a commutator 11 mounted integral with the axis of the rotor 10 passing through the supporting member 55. FIG. 3 also shows brushes 35, mounted on brush holders 30, adapted to contact with the segments of the commutator 11.

FIG. 3 also shows electrical connection members 20 connected to the brush holders 30. The connection members 20 provide the connection between the brush holders 30 and the electrical supply posts 110 in the mounting configuration of the motor of FIG. 2. The connection members 20 extend substantially parallel to the supporting member 55 in a plane substantially perpendicular to the axis of the rotor 10. The connection members 20 can thus meet the electrical supply posts 110 that are situated in a plane parallel to the axis of the rotor 10.

FIG. 4 also shows the connection members 20 connected to the brush holders 30 and placed in the commutator housing 50. FIG. 4 clearly shows the arrangement of the connection members 20 in the commutator housing 50. It is advantageous to assemble the connection members 20 in the same way as the brush holders 30 and preferably at the same time. Thus, for assembling the latch motor 60, the connection members 20 will preferably be mounted in the commutator housing 50 with the brush holders 30 and the brushes 35, after which the supporting member 55 is fitted to immobilize these components inside the commutator housing 50.

As illustrated here, the connection members 20 are flexible tongue members each having a first bossed region 21 adapted to come into contact with the electrical supply posts 110 and a second bossed region 22 adapted to make contact with the brush holders 30. However, according to an embodiment not illustrated, the connection members 20 are metal and can be integral with the brush holders 30. In other words, the same metal connection part can be shaped to carry the brushes 35 and extend over the commutator housing 50 up to the point of connection with the electrical supply posts 110.

Each connection member 20 that is a flexible tongue member has a flexible region 23 obtained by forming a step by folding it generally perpendicular to the longitudinal extension of the flexible tongue member. The length of the connection members 20, in other words from the point where it is connected to brush holder 30 and the point where it is connected to the electrical supply posts 110, is selected to be slightly greater than necessary to ensure good electrical contact by a resilient force maintaining connection.

Additionally, the commutator housing 50 includes slots 51 designed to receive the electrical supply posts 110. Before connection is made, the connection members 20 extend at least partially over the top of the slots 51. When connection is made, the electrical supply posts 110 push back the flexible tongue members while penetrating into the slots 51 and slightly compressing the flexible region 23 thereof. When connection is established, the connection members 20 are consequently urged against the electrical supply posts 110 by the spring action of the flexible regions 23, and good electrical contact is thus ensured.

The commutator housing 50 also includes a groove 52 located between the two slots 51 for insertion of the electrical supply posts 110. The groove 52 is adapted to receive a stud 105 of the latch housing 100. The stud 105 is provided on the connection conduit 101 of the latch housing 100 and projects between the two electrical supply posts 110. It is, for example, directly molded together with the connection conduit 101 in plastic material. The cooperation between the stud 105 and the groove 52 of the commutator housing 50 ensures angular positioning of the motor in the latch housing 100 and limits mechanical stresses on the axis of the rotor 10 in the axial direction.

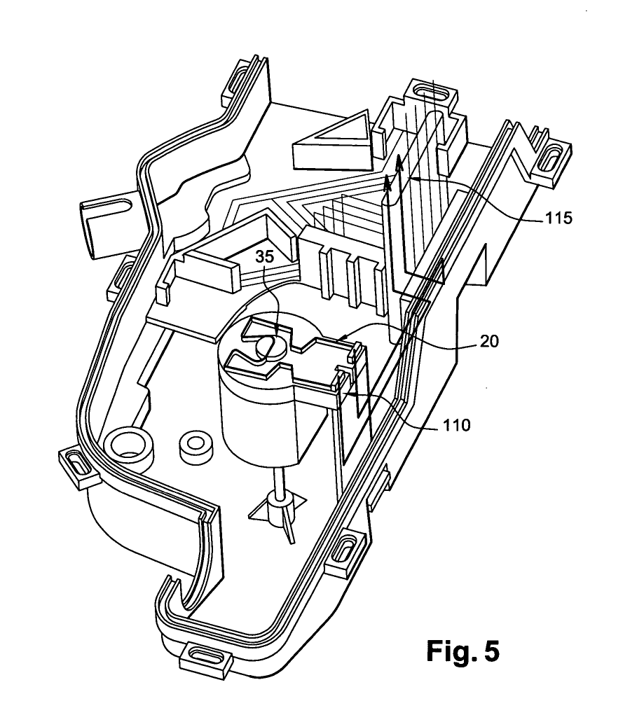

FIG. 5 shows the electrical connections inside the latch housing 100. Conventionally, an electrically-operated latch includes a plurality of sensors determining certain states of the latch. One such state sensor of the latch can be a switch supplying binary information regarding the kinematic position of a given element of the latch. One can, for example, make reference to European patent application EP-A-0 059 658 that illustrates state switches in a latch with integrated electrical locking. Typically, the information supplied by the sensor is sent to an electronic unit adapted to control one or several latch motors. The electronic unit can thus switch the current in the electrical supply posts 110 of the latch motor 60.

On FIG. 5, the latch housing 100 has leads constituting a lead frame 115 overmolded in the side walls and the base of the latch housing 100. The leads provide the electrical connection between the electrical supply posts 110 and a connector of a wiring harness, for example connected to the vehicle on-board network, to a (nonillustrated) electronic unit, to (nonillustrated) sensors and to other electrical components of the latch.

The present invention provides an electrically-operated latch having simple assembly with a motor mounted substantially perpendicular to the base of the housing without significant modification to the motor and without using a supplementary component to make assembly possible.

Obviously, this invention is not limited to the embodiments described by way of example. Thus, the commutator housing can extend at the rear of the stator of the motor as illustrated in the drawings or in front of it between the stator and the gear wheel mounted on the rotor shaft. Similarly, the connection conduit can be situated at a side wall of the housing as illustrated in the drawings, or in a central region of the latch housing.

The foregoing description is only exemplary of the principles of the invention. Many modifications and variations are possible in light of the above teachings. It is, therefore, to be understood that within the scope of the appended claims, the invention may be practiced otherwise than using the example embodiments which have been specifically described. For that reason the following claims should be studied to determine the true scope and content of this invention.

What is claimed is:

1. An electric motor comprising:
a rotor having an axis; and
a commutator housing including at least two connection members that provide a connection between brush holders and electrical supply posts, wherein the electrical supply posts extend substantially parallel to the axis of the rotor.

2. The electric motor according to claim 1, wherein the at least two connection members extend in a plane substantially perpendicular to the axis of the rotor.

3. The electric motor according to claim 1, wherein the at least two connection members are flexible tongue members.

4. The electric motor according to claim 3, wherein the flexible tongue members each include a first bossed region that contacts one of the electrical supply posts.

5. The electric motor according to claim 4, wherein the flexible tongue members each include a second bossed region that contacts one of the brush holders.

6. The electric motor according to claim 1, wherein the at least two connection members are each integral with one of the brush holders.

7. The electric motor according to claim 1, wherein the commutator housing includes at least two slots that each receive one of the electrical supply posts.

8. The electric motor according to claim 7, further including an angular positioning stud, and the commutator housing includes a groove to receive the angular positioning stud.

9. An electrically-operated latch comprising:
a latch housing including a base and side walls;
an electric motor including:
a rotor having an axis, and
a commutator housing including at least two connection members that provide a connection between brush holders and at least two electrical supply posts, wherein the electric motor is mounted in the latch housing with the axis of the rotor substantially perpendicular to the base of the latch housing; and
the at least two electrical supply posts extending substantially parallel to the axis of the rotor and each electrically connected to one of the at least two connection members of the electric motor.

10. The electrically-operated latch according to claim 9, wherein the at least two electrical supply posts are overmolded inside a connection conduit that extends substantially parallel to the side walls of the latch housing.

11. The electrically-operated latch according to claim 10, wherein the connection conduit includes a stud and the commutator housing includes a groove, and the stud cooperates with the groove to angularly position the electric motor.

12. The electrically-operated latch according to claim 10, wherein the connection conduit includes at least one abutment to axially position the electric motor.

13. An openable member of a vehicle comprising:
an electrically-operated latch including:
an electric motor including a rotor having an axis, the electric motor further including a commutator housing having at least two connection members that provide a connection between brush holders and at least two electrical supply posts, wherein the electric motor is mounted in the latch housing with the axis of the rotor substantially perpendicular to a base of the latch housing; and
the at least two electrical supply posts extending substantially parallel to the axis of the rotor and each electrically connected to one of the at least two connection members.
